(19) United States
(12) Patent Application Publication
(10) Pub. No.: US 2020/0316502 A1
(43) Pub. Date: Oct. 8, 2020

(54) Novel Single-Stage Filtration System

(71) Applicant: Tianjin Tianchuang Best Pure Environmental Science And Technology Co., Ltd., Tianjin (CN)

(72) Inventor: Enyu Wei, TIANJIN (CN)

(73) Assignee: Tianjin Tianchuang Best Pure Environmental Science And Technology Co., Ltd., Tianjin (CN)

(21) Appl. No.: 16/374,577

(22) Filed: Apr. 3, 2019

(51) Int. Cl. B01D 35/30; B01D 29/96; C02F 1/28

(52) U.S. Cl. CPC B01D 35/30; B01D 29/96; C02F 1/283; C02F 2201/004; B01D 2201/302; B01D 2201/40; B01D 2101/02; B01D 2201/304

(57) ABSTRACT

The Invention relates to a novel single-stage filtration system, including a joint and a filter element, wherein the joint is mounted on the filter element, the joint includes a joint body, a water inlet sealing ring, a water inlet cover plate and a water inlet clamp, a water outlet sealing ring, a water outlet cover plate and a water outlet clamp, the joint body includes a water inlet cavity, a water outlet cavity, a water inlet joint, a water outlet joint, a connecting flange, a water inlet sealing cavity, a water outlet sealing cavity, a hanging piece and a reinforcing rib, the water inlet cavity of the joint body is an L-shaped cylindrical cavity, one end of the water inlet cavity is connected with the water inlet joint, and the other end of the water inlet cavity is in the water inlet sealing cavity, the water outlet cavity is a circular cylindrical cavity. The Invention improves the wear of a connector caused by the repeated disassembly of a filter through the arrangement of the novel single-stage filtration system, and ensures the sealing performance of the filtration system.

### TECHNICAL FIELD

The Invention relates to a novel single-stage filtration system.

### TECHNICAL BACKGROUND

Currently, a single-stage filtration system is a threaded upper and lower opening-closing end cover type filtration system. When a filter bottle is disassembled, it will appear that a bottle body needs to be unscrewed. When the bottle body and an end cover are screwed too much, a compression angle of the bottle body is tight and it is difficult to carry out disassembly.

### SUMMARY

In order to overcome the deficiencies of the prior art, the Invention provides a novel single-stage filtration system.

In order to solve the above problems, the technical solution adopted by the Invention is:

a novel single-stage filtration system includes a joint and a filter element, wherein the joint is mounted on the filter element, the joint includes a joint body, a water inlet sealing ring, a water inlet cover plate, a water inlet clamp, a water outlet sealing ring, a water outlet cover plate and a water outlet clamp.

the joint body includes a water inlet cavity, a water outlet cavity, a water inlet joint, a water outlet joint, a connecting flange, a water inlet sealing cavity, a water outlet sealing cavity, a hanging piece, a reinforcing rib, the water inlet cavity of the joint body is an L-shaped cylindrical cavity, one end of the water inlet cavity is connected with the water inlet joint, and the other end of the water inlet cavity is in the water inlet sealing cavity, the water outlet cavity is a circular cylindrical cavity, one end of the water outlet cavity is connected with the water outlet joint, the water outlet joint is at the center of the water outlet cavity, the water inlet joint is on one side of the joint body, the water inlet joint is provided thereon with a water pipe hole I, a sealing ring hole I, and a cover plate hole I, the water pipe hole I is connected with the water pipe, the sealing ring hole I is provided therein with the water inlet sealing ring, the water inlet cover plate is mounted in the cover plate hole I, a water inlet clamp is mounted on the water inlet cover plate, the water outlet joint is above the joint body, the water outlet joint is provided thereon with a water pipe hole II, a sealing ring hole II, and a cover plate hole II, the water pipe hole II is connected with the water pipe, the water outlet sealing ring is mounted in the sealing ring hole II, the water outlet cover plate is mounted in in the cover plate hole II, and the water outlet clamp is mounted on the water outlet cover plate;

the connecting flange is at the bottom of the joint body, the connecting flanges are two C-shaped lug flanges, the water outlet sealing cavity is at the center of the filter element body, one end of the water outlet sealing cavity forms a sealing structure together with the filter element body and the water inlet sealing ring, and the other end of the water outlet sealing cavity is connected with a water outlet boss, the middle portion of the water inlet sealing cavity is the water outlet cavity, the water inlet sealing cavity has an annular structure, the water inlet sealing cavity is located inside the joint body, one end of the water inlet sealing cavity forms the sealing structure together with the carbon rod cover and the water outlet sealing ring, and the hanging piece is behind the joint;

the filter element includes an end cover, a filter element body, a carbon rod cover, a carbon rod bottom, a carbon rod, the water inlet sealing ring and the water outlet sealing ring, the end cover is mounted at the bottom of the filter element body, the carbon rod cover is mounted in the filter element body, the carbon rod bottom is in the end cover, and the carbon rod is mounted between the carbon rod cover and the carbon rod bottom;

one end of the end cover is a concave stop port;

the filter element body has a barrel-shaped structure, the filter element body is provided thereon with a water inlet sealing ring groove, a convex stop port, a filter element flange, an inner hole and a sheath groove, the water inlet sealing ring groove forms the sealing structure together with the water inlet cavity and the water inlet sealing ring, the filter element body is provided thereon with a convex stop port, the concave stop port cooperates with the convex stop port, the filter element flange is located at the lower portion of the water inlet sealing ring groove, the filter element flange cooperates with the connecting flange, the inner hole is at the center of the top of the filter element body, and the water inlet cavity consists of the inner hole and the carbon rod cover.

Preferably, the upper portion of the filter element body cooperates with the carbon rod cover to have a plurality of water-passing grids arranged.

Preferably, the hanging piece has two bosses thereon, the two bosses are located at the back of the hanging piece, and the two bosses have two through holes thereon.

Preferably, the bottom of the end cover is provided thereon with a handle.

Preferably, the sheath groove is located on both sides of the filter element body, and the sheath groove is connected with a snap joint on the sheath.

Preferably, the carbon rod cover consists of a carbon rod cover water outlet cavity, a water outlet sealing ring groove and a carbon rod pasting surface I, the carbon rod cover water outlet cavity is at the center of the carbon rod cover, the water outlet sealing ring groove forms the sealing structure together with the water outlet sealing ring and the water outlet cavity of the joint, and the carbon rod pasting surface I is on the inner side of the carbon rod cover.

Preferably, the bottom of the carbon rod has a carbon rod adhesion surface II and a rib position, the carbon rod adhesion surface II is adhered to the carbon rod, and the rib position is connected with the end cover.

Preferably, the carbon rod is an annular columnar structure, one end of the carbon rod cooperates with the carbon rod pasting surface, and the other end of the carbon rod cooperates with a pasting carbon rod pasting surface II.

Because the above technical solution is adopted, compared with the prior art, the Invention improves the wear of a connector caused by the repeated disassembly of a filter through the arrangement of the single-stage filtration system, and ensures the sealing performance of the filtration system.

The Invention will be further described below in conjunction with the drawings and embodiments.

### BRIEF DESCRIPTION OF DRAWINGS

FIG. 1 is a front view of a novel single-stage filtration system of the Invention.

FIG. 2 is a left side view of a novel single-stage filtration system of the Invention.

FIG. 3 is a front cross-sectional view of a novel single-stage filtration system of the Invention.

FIG. 4 is an axial view of a novel single-stage filtration system of the Invention.

FIG. 5 is a front cross-sectional view of a joint of a novel single-stage filtration system of the Invention.

FIG. 6 is an upward view of a joint of a novel single-stage filtration system of the Invention.

FIG. 7 is a front cross-sectional view of an element body of a novel single-stage filtration system of the Invention.

FIG. 8 is an axial view of an element body of a novel single-stage filtration system of the Invention.

FIG. 9 is a front cross-sectional view of an end cover of a novel single-stage filtration system of the Invention.

FIG. 10 is an upward view of an end cover of a novel single-stage filtration system of the Invention.

FIG. 11 is a front cross-sectional view of a carbon rod cover of a novel single-stage filtration system of the Invention.

FIG. 12 is a front cross-sectional view of a carbon rod bottom of a novel single-stage filtration system of the Invention.

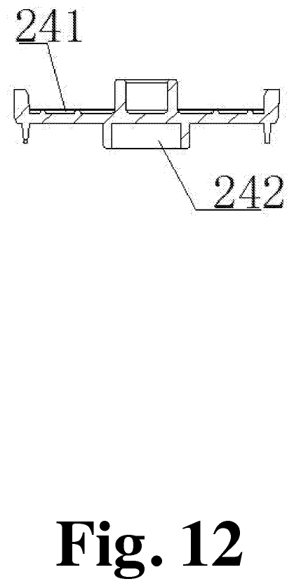

FIG. 13 is a front cross-sectional view of a water inlet joint of a novel single-stage filtration system of the Invention.

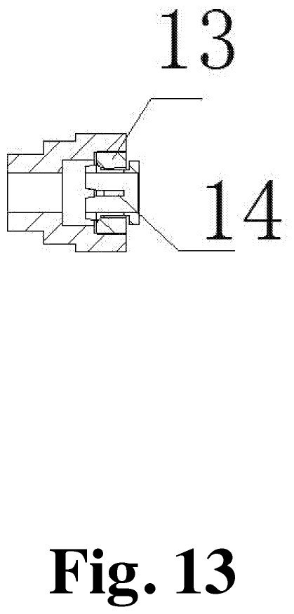

FIG. 14 is a front cross-sectional view of a water outlet joint of a novel single-stage filtration system of the Invention.

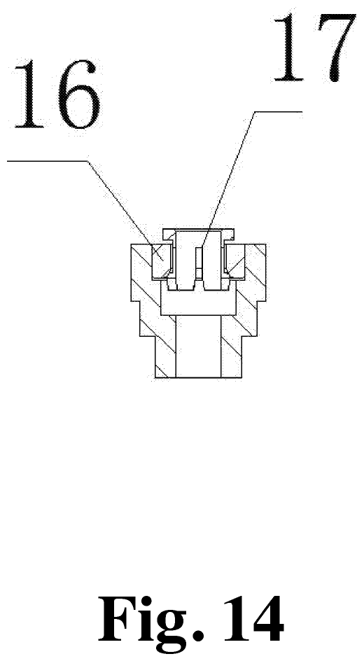

FIG. 15 is a front view of a sheath of a novel single-stage filtration system of the Invention.

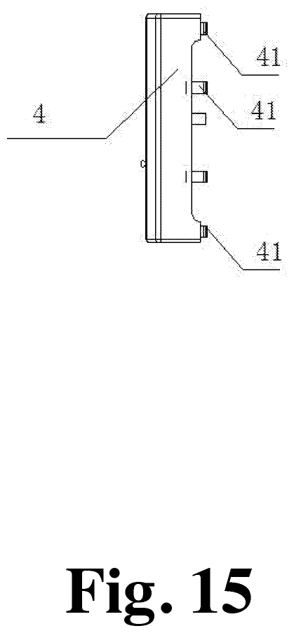

FIG. 16 is an axial view of a sheath of a novel single-stage filtration system of the Invention.

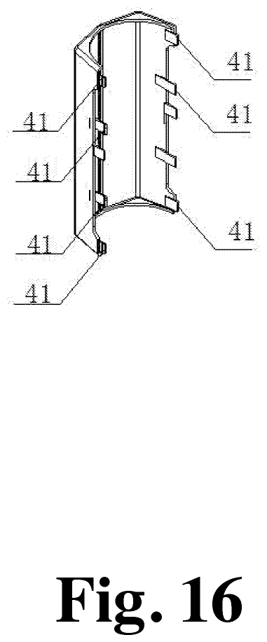

In the drawings: 1: Joint, 11: Joint Body, 111: Water Inlet Cavity, 112: Water Outlet Cavity, 113: Water Inlet Joint, 113a: Water Pipe Hole I, 113b: Sealing Ring Hole I, 113c: Cover Hole I , 114: Water Outlet Joint, 114a: Water Pipe Hole II, 114b: Sealing Ring Hole II, 114c: Cover Plate Hole II, 115: Connecting Flange, 116: Water Inlet Sealing Cavity, 117: Water Outlet Sealing Cavity, 118: Hanging Piece, 119: Reinforcing Rib, 12: Water Inlet Sealing Ring, 13: Water Inlet Cover Plate, 14: Water Inlet Clamp, 15: Water Outlet Sealing Ring, 16: Water Outlet Cover Plate, 17: Water Outlet Clamp, 2: Filter Element, 21: End Cover, 211: Concave Stop Port, 212: Handle, 22: Filter Element Body, 221: Water Inlet Sealing Ring Groove, 222: Convex Stop Port, 223: Filter Element Flange, 224: Inner Hole, 225: Sheath Groove, 226: Water-Passing Grid, 23: Carbon Rod Cover, 231: Carbon Rod Cover Water Outlet Cavity, 232: Water Outlet Sealing Ring Groove, 233: Carbon Rod Pasting Surface I, 24: Carbon Rod Bottom, 241: Carbon Rod Adhesion Surface II, 242: Rib Position, 25: Carbon Rod, 3: Water Outlet Boss, 4: Sheath, 41: Snap Joint.

### DETAILED DESCRIPTION

### EXAMPLE

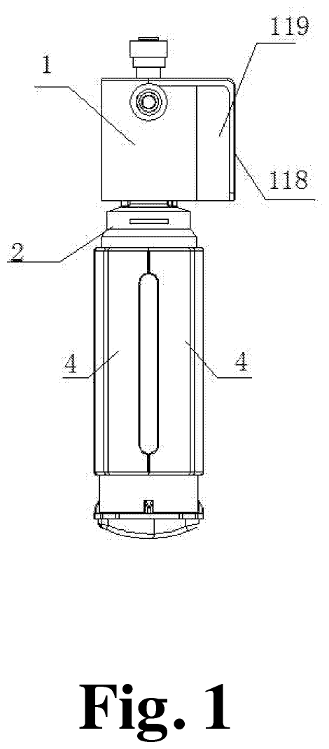

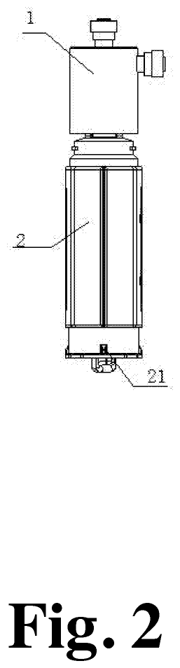

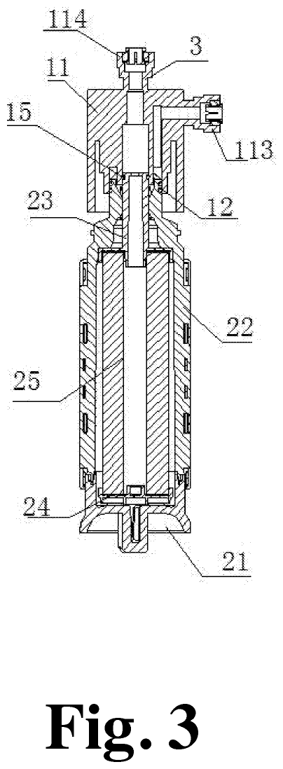

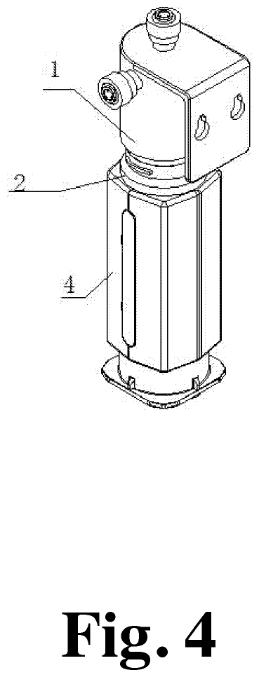

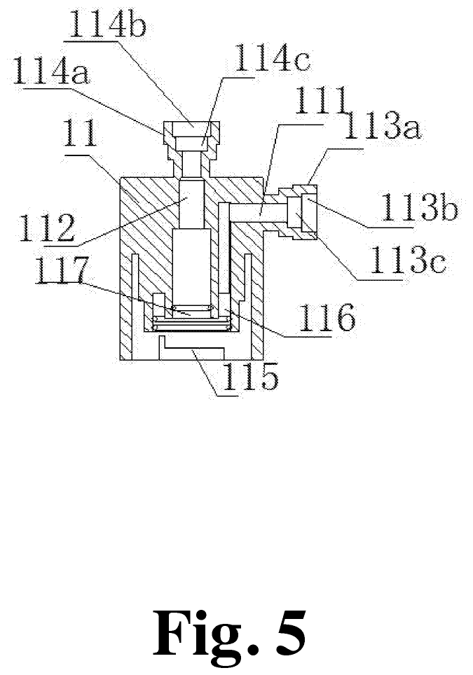

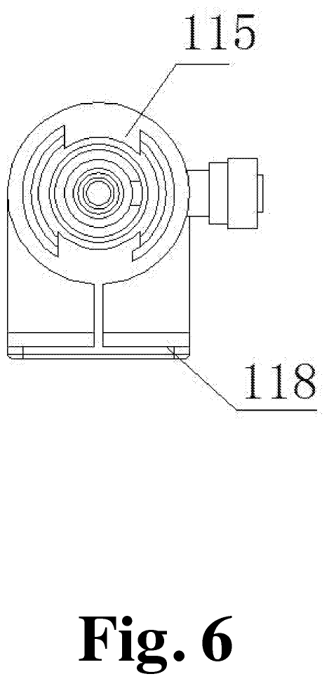

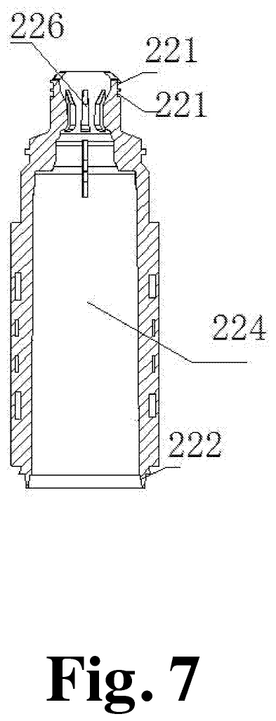

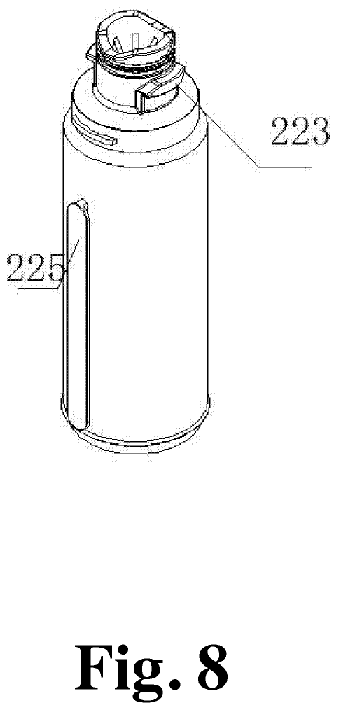

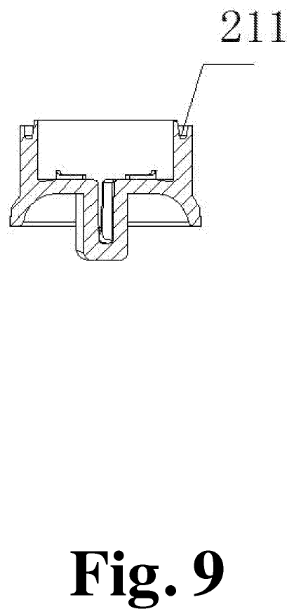

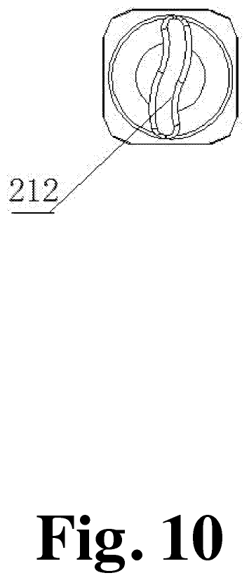

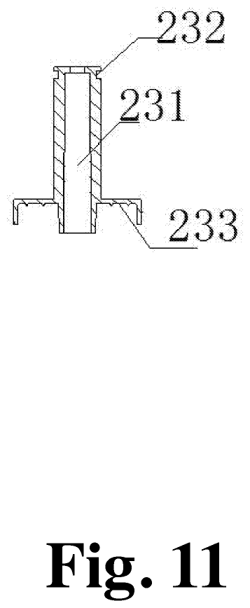

As shown in FIGS. 1-11, a novel single-stage filtration system includes a joint 1 and a filter element 2, wherein the joint 1 is mounted on the filter element 2, the joint 1 includes a joint body 11, a water inlet sealing ring 12, a water inlet cover plate 13, a water inlet clamp 14, a water outlet sealing ring 15, a water outlet cover plate 16 and a water outlet clamp 17,

the joint body 11 includes a water inlet cavity 111, a water outlet cavity 112, a water inlet joint 113, a water outlet joint 114, a connecting flange 115, a water inlet sealing cavity 116, a water outlet sealing cavity 117, a hanging piece 118, a reinforcing rib 119, the water inlet cavity 111 of the joint body 11 is an L-shaped cylindrical cavity, one end of the water inlet cavity 111 is connected with the water inlet joint 113, and the other end of the water inlet cavity 111 is in the water inlet sealing cavity 116, the water outlet cavity 112 is a circular cylindrical cavity, one end of the water outlet cavity 112 is connected with the water outlet joint 114, the water outlet joint 114 is at the center of the water outlet cavity 112, the water inlet joint 113 is on one side of the joint body 11, the water inlet joint 113 is provided thereon with a water pipe hole I 113a, a sealing ring hole I 113b, and a cover plate hole I 113c, the water pipe hole I 113a is connected with the water pipe, the sealing ring hole I 113b is provided therein with the water inlet sealing ring 12, the water inlet cover plate 13 is mounted in the cover plate hole I 113c, a water inlet clamp 14 is mounted on the water inlet cover plate 13, the water outlet joint 114 is above the joint body 11, the water outlet joint 114 is provided thereon with a water pipe hole II 114a, a sealing ring hole II 114b, and a cover plate hole II 114c, the water pipe hole II 114a is connected with the water pipe, the water outlet sealing ring 15 is mounted in the sealing ring hole II, the water outlet cover plate 16 is mounted in in the cover plate hole II 114c, and the water outlet clamp 17 is mounted on the water outlet cover plate 16;

the connecting flange 115 is at the bottom of the joint body 11, the connecting flanges 115 are two C-shaped lug flanges, the water outlet sealing cavity 117 is at the center of the filter element body 22, one end of the water outlet sealing cavity 117 forms a sealing structure together with the filter element body 22 and the water inlet sealing ring 12, and the other end of the water outlet sealing cavity 117 is connected with a water outlet boss 3, the middle portion of the water inlet sealing cavity 116 is the water outlet cavity 112, the water inlet sealing cavity 1116 has an annular structure, the water inlet sealing cavity 116 is located inside the joint body 11, one end of the water inlet sealing cavity 116 forms the sealing structure together with the carbon rod cover 23 and the water outlet sealing ring 26, and the hanging piece 118 is behind the joint;

the filter element 2 includes an end cover 21, a filter element body 22, a carbon rod cover 23, a carbon rod bottom 24, a carbon rod 25, the water inlet sealing ring 12 and the water outlet sealing ring 15, the end cover 21 is mounted at the bottom of the filter element body 22, the carbon rod cover 23 is mounted in the filter element body 22, the carbon rod bottom 24 is in the end cover 21, and the carbon rod 25 is mounted between the carbon rod cover 23 and the carbon rod bottom 24;

one end of the end cover 21 is a concave stop port 211;

the filter element body 22 has a barrel-shaped structure, the filter element body 22 is provided thereon with a water inlet sealing ring groove 221, a convex stop port 222, a filter element flange 223, an inner hole 224 and a sheath groove 225, the water inlet sealing ring groove 221 forms the sealing structure together with the water inlet cavity 111 and the water inlet sealing ring 12, the filter element body 22 is provided thereon with a convex stop port 222, the concave stop port 211 cooperates with the convex stop port 222, the filter element flange 223 is located at the lower portion of the water inlet sealing ring groove 221, the filter element flange 223 cooperates with the connecting flange 115, the inner hole 224 is at the center of the top of the filter element body 22, and the water inlet cavity consists of the inner hole 224 and the carbon rod cover 23.

Further, the upper portion of the filter element body 22 cooperates with the carbon rod cover 23 to have a plurality of water-passing grids 226 arranged, and water inlet is realized by the arrangement of the plurality of water-passing grids 226.

Further, the hanging piece has two bosses thereon, the two bosses are located on the back of the hanging piece, the two bosses have two through holes thereon, and the installation of the hanging piece is realized by the arrangement of the two through holes.

Further, the bottom of the end cover 21 is provided thereon with a handle 212, and the arrangement of the handle 212 facilitates the installation of the end cover 21.

Further, the sheath groove 225 is located at two sides of the filter element body 22, a sheath 4 is mounted outside the filter element body 22, the sheath groove 225 is connected with a snap joint on the sheath, the arrangement of the sheath groove 225 facilitates the installation of the sheath 4, the two sheaths 4 are mounted on the outer side of the filter element body 22, and the snap joint 41 on the sheath 4 is blocked and engaged in the sheath groove 225 to realize the positioning of the sheath 4.

Further, the carbon rod cover 23 consists of a carbon rod cover water outlet cavity 231, a water outlet sealing ring 232, and a carbon rod pasting surface I 233, the carbon rod cover water outlet cavity 231 is at the center of the carbon rod cover 23, the water outlet sealing ring groove 232 forms the sealing structure together with the water outlet sealing ring 15 and the water outlet cavity 112 of the joint, the carbon rod pasting surface 233 is inside the carbon rod cover 23, the carbon rods 25 is positioned by the arrangement of the carbon rod cover 23.

Further, the carbon rod bottom 24 has a carbon rod adhesion surface II 241 and a rib position 242 thereon, the carbon rod adhesion surface II 241 is adhered to the carbon rod 25, the rib position 242 is connected with the end cover 21, and the carbon rod is positioned by the arrangement of the carbon rod bottom 24.

Further, the carbon rod 25 is an annular columnar structure, one end of the carbon rod 25 cooperates with the carbon rod pasting surface I 233, and the other end of the carbon rod 25 cooperates with a pasting carbon rod pasting surface II 241, and the carbon rod is positioned by the arrangement of the carbon rod pasting surface I 233 and the pasting carbon rod pasting surface II 241.

In the Invention, pre-filtration water enters the water inlet cavity 11 of the joint body 11 via a water inlet end, after water body passes through the water inlet sealing cavity 116 and passes through the water-passing grid 226 between the carbon rod cover 23 and the filter element body 22, the water body enters the filter element body 22, then enters the carbon rod 25 and enters the inner portion of the filter element body 22, and then the filtered water is filtered through the carbon rod 25 and enters the center of the carbon rod 25, and then the entering purified water sequentially passes through the center of the carbon rod cover 23 and the water outlet cavity 112 of the joint to realize water outlet.

In the Invention, after the carbon rod cover 23 is mounted on the uppermost end of the filter element body 22, the carbon rod 25 is then mounted on the carbon rod cover 23 so that the carbon rod pasting surface 233 is attached to the carbon rod 25, and then the carbon rod bottom 24 is mounted below the carbon rod 25 so that the rib position 242 is attached to an upper end cover 21, the carbon rod pasting surface II 241 is attached to the carbon rod 25, and then the concave stop port 211 of the end cover 21 and the convex stop port 222 of the filter element body 22 realize the installation of the end cover, and then the joint 1 is mounted on one end of the carbon rod cover 23 after the connecting flange 115 on the joint 1 is misaligned with as well as blocked and engaged in the filter element flange 223, the joint 1 is rotated to realize the installation and the snapping of the joint 1, which facilitate the disassembly and the installation of the joint.

Because the above technical solution is adopted, compared with the prior art, the Invention improves the wear of a connector caused by the repeated disassembly of a filter through the arrangement of the single-stage filtration system, and ensures the sealing performance of the filtration system.

The Invention is not limited to the above-described preferred embodiments, and any person skilled in the art should be aware of the structural changes made in the light of the Invention, any technical solution having the same or similar to that of the Invention belongs to the scope of protection of the Invention.

1. A novel single-stage filtration system, comprising a joint and a filter element, wherein the joint is mounted on the filter element, the joint comprises a joint body, a water inlet sealing ring, a water inlet cover plate, a water inlet clamp, a water outlet sealing ring, a water outlet cover plate and a water outlet clamp. The joint body comprises a water inlet cavity, a water outlet cavity, a water inlet joint, a water outlet joint, a connecting flange, a water inlet sealing cavity, a water outlet sealing cavity, a hanging piece, a reinforcing rib, the water inlet cavity of the joint body is an L-shaped cylindrical cavity, one end of the water inlet cavity is connected with the water inlet joint, and the other end of the water inlet cavity is in the water inlet sealing cavity, the water outlet cavity is a circular cylindrical cavity, one end of the water outlet cavity is connected with the water outlet joint, the water outlet joint is at the center of the water outlet cavity, the water inlet joint is on one side of the joint body, the water inlet joint is provided thereon with a water pipe hole I, a sealing ring hole I, and a cover plate hole I, the water pipe hole I is connected with the water pipe, the sealing ring hole I is provided therein with the water inlet sealing ring, the water inlet cover plate is mounted in the cover plate hole I, a water inlet clamp is mounted on the water inlet cover plate, the water outlet joint is above the joint body, the water outlet joint is provided thereon with a water pipe hole II, a sealing ring hole II, and a cover plate hole II, the water pipe hole II is connected with the water pipe, the water outlet sealing ring is mounted in the sealing ring hole II, the water outlet cover plate is mounted in in the cover plate hole II, and the water outlet clamp is mounted on the water outlet cover plate;
The filter element comprises an end cover, a filter element body, a carbon rod cover, a carbon rod bottom, a carbon rod, the water inlet sealing ring and the water outlet sealing ring, the end cover is mounted at the bottom of the filter element body, the carbon rod cover is mounted in the filter element body, the carbon rod bottom is in the end cover, and the carbon rod is mounted between the carbon rod cover and the carbon rod bottom;
one end of the end cover is a concave stop port;
the connecting flange is at the bottom of the joint body, the connecting flanges are two C-shaped lug flanges, the water outlet sealing cavity is at the center of the filter element body, one end of the water outlet sealing cavity forms a sealing structure together with the filter element body and the water inlet sealing ring, and the other end of the water outlet sealing cavity is connected with a water outlet boss, the middle portion of the water inlet sealing cavity is the water outlet cavity, the water inlet sealing cavity has an annular structure, the water inlet sealing cavity is located inside the joint body, one end of the water inlet sealing cavity forms the sealing structure together with the carbon rod cover and the water outlet sealing ring, and the hanging piece is behind the joint;
the filter element body has a barrel-shaped structure, the filter element body is provided thereon with a water inlet sealing ring groove, a convex stop port, a filter element flange, an inner hole and a sheath groove, the water inlet sealing ring groove forms the sealing structure together with the water inlet cavity and the water inlet sealing ring, the filter element body is provided thereon with a convex stop port, the concave stop port cooperates with the convex stop port, the filter element flange is located at the lower portion of the water inlet sealing ring groove, the filter element flange cooperates with the connecting flange, the inner hole is at the center of the top of the filter element body, and the water inlet cavity consists of the inner hole and the carbon rod cover.

2. The novel single-stage filtration system of claim 1, wherein the upper portion of the filter element body cooperates with the carbon rod cover to have a plurality of water-passing grids arranged.

3. The novel single-stage filtration system according to claim 1, wherein the hanging piece has two bosses thereon, the two bosses are located at the back of the hanging piece, and the two bosses have two through holes thereon.

4. The novel single-stage filtration system of claim 1, wherein the bottom of the end cover is provided thereon with a handle.

5. The novel single-stage filtration system according to claim 1, wherein the sheath groove is located on both sides of the filter element body, a sheath is mounted outside the filter element body, and the sheath groove is connected with a snap joint on the sheath.

6. The novel single-stage filtration system according to claim 1, wherein the carbon rod cover consists of a carbon rod cover water outlet cavity, a water outlet sealing ring groove and a carbon rod pasting surface I, the carbon rod cover water outlet cavity is at the center of the carbon rod cover, the water outlet sealing ring groove forms the sealing structure together with the water outlet sealing ring and the water outlet cavity of the joint, and the carbon rod pasting surface I is on the inner side of the carbon rod cover.

7. The novel single-stage filtration system according to claim 6, wherein the bottom of the carbon rod has a carbon rod adhesion surface II and a rib position, the carbon rod adhesion surface II is adhered to the carbon rod, and the rib position is connected with the end cover.

8. The novel single-stage filtration system according to claim 7, wherein the carbon rod is a annular columnar structure, one end of the carbon rod cooperates with the carbon rod pasting surface, and the other end of the carbon rod cooperates with a pasting carbon rod pasting surface II.
